(19) United States
(12) Patent Application Publication
(10) Pub. No.: US 2026/0197228 A1
(43) Pub. Date: Jul. 9, 2026

(54) LEARNING APPARATUS, SELECTION APPARATUS, LEARNING METHOD, SELECTION METHOD, AND PROGRAM

(71) Applicant: NTT, Inc., Tokyo (JP)

(72) Inventors: Shunsuke KANAI, Tokyo (JP); Masashi KOBAYASHI, Tokyo (JP); Hiroaki MATSUBAYASHI, Tokyo (JP); Kazuaki AKASHI, Tokyo (JP); Mayu YAMAZOE, Tokyo (JP)

(21) Appl. No.: 19/130,257

(22) PCT Filed: Dec. 5, 2022
(86) PCT No.: PCT/JP2022/044731

§ 371 Date: May 15, 2025

(51) Int. Cl. H04L 41/0668

(52) U.S. Cl. CPC H04L 41/0668

(57) ABSTRACT

A learning device that determines a reference value used to select a specific plurality of failed facilities to be preferentially recovered from among a plurality of failed facilities generated in a network that provides a communication service and includes a plurality of facilities, the learning device including: a calculation unit that executes processing of calculating total priority of a pattern including a specific number of failed facilities while replacing a failed facility in the pattern; and a learning unit that determines the reference value based on a difference between an approximate solution obtained by the processing executed by the calculation unit and an optimal solution.

### TECHNICAL FIELD

The present invention relates to a technique for recovering from a failure in a communication facility caused by a disaster.

### BACKGROUND ART

A communication network used by a communications carrier for providing a communication service has a configuration in which a plurality of communication buildings is connected by a transmission path. In general, communication buildings employ a redundant configuration having a ring configuration. That is, even if a failure occurs in one communication building and communication becomes impossible, it is possible to continue the service in a standby system (single system).

Since the ring configuration has multiple stages, if communication cannot be performed in a higher ring, communication cannot be performed in a lower ring. There is not only a difference in importance between the high and low levels of the rings, but also a difference in importance among various lines accommodated in the communication buildings.

At the occurrence of a disaster, in many cases, a failure occurs in a plurality of communication buildings. If a failure occurs in the communication buildings, it is necessary to recover from the failure, but there is a limit to resources for the recovery. Therefore, if a failure occurs in a plurality of communication buildings, it is necessary to determine which communication building is to be preferentially recovered among the plurality of communication buildings.

### CITATION LIST

### Non Patent Literature

Non Patent Literature 1: “Study on Method of Identifying Service Influence on Device Hierarchy”, Shohei Nishikawa, Masataka Sato, Kenji Murase, Kimihiko Fukami, Kenichi Tayama, IEICE technical report, vol. 120, no. 109, ICM2020-8, pp. 1-6, July 2020

### SUMMARY OF INVENTION

### Technical Problem

However, the recovery priority of communication buildings varies depending on the high and low levels of the rings, the ripple effect, the type of accommodated line, and the like. Thus, a huge amount of calculation is required to determine a communication building to be preferentially recovered, which causes a problem of delayed determination. Note that this problem may occur not only in the communication buildings but also in general communication facilities.

The present invention has been made in view of the above points, and an object thereof is to provide a technique for quickly determining a communication facility to be recovered when a failure occurs in a plurality of communication facilities in a network.

### Solution to Problem

According to the disclosed technique, there is provided a learning device that determines a reference value used to select a specific plurality of failed facilities to be preferentially recovered from among a plurality of failed facilities generated in a network that provides a communication service and includes a plurality of facilities, the learning device including: a calculation unit that executes processing of calculating total priority of a pattern including a specific number of failed facilities while replacing a failed facility in the pattern; and a learning unit that determines the reference value based on a difference between an approximate solution obtained by the processing executed by the calculation unit and an optimal solution.

### Advantageous Effects of Invention

According to the disclosed technique, when a failure occurs in a plurality of communication facilities in a network, it is possible to quickly determine a communication facility to be recovered.

### BRIEF DESCRIPTION OF DRAWINGS

FIG. 1 is a diagram illustrating an overall configuration example of a system in a first embodiment.

FIG. 2 is a flowchart for explaining the operation of a selection device 100 in the first embodiment.

FIG. 3 illustrates a network configuration example.

FIG. 4 is a flowchart for explaining the operation of the selection device 100 in the first embodiment.

FIG. 5 illustrates an example of facilities affected by a failure.

FIG. 6 illustrates an example of facilities affected by a failure.

FIG. 7 illustrates a specific example of processing.

FIG. 8 is a flowchart for explaining the operation of the selection device 100 in the first embodiment.

FIG. 9 illustrates a specific example of the processing.

FIG. 10 illustrates a specific example of the processing.

FIG. 11 illustrates a specific example of the processing.

FIG. 12 illustrates a state where total priority increases as a generation progresses.

FIG. 13 is a network configuration example in an example of the first embodiment.

FIG. 14 is a diagram illustrating priority in Example 1-1.

FIG. 15 is a diagram illustrating simulation conditions in Example 1-1.

FIG. 16 is a diagram illustrating results of Example 1-1.

FIG. 17 is a diagram illustrating priority in Example 1-2.

FIG. 18 is a diagram illustrating results of Example 1-2.

FIG. 19 is a diagram for explaining a problem to be solved in a second embodiment.

FIG. 20 is a diagram illustrating an overall configuration example of a system in the second embodiment.

FIG. 21 is a flowchart for explaining the operation of the selection device 100 (learning device) in the second embodiment.

FIG. 22 is a diagram for explaining calculation of a difference between an optimal value and an approximate solution.

FIG. 23 is a diagram for explaining an example of an acceptance determination value.

FIG. 24 is a flowchart for explaining the operation of the selection device 100 in the second embodiment.

FIG. 25 is a diagram for explaining an example of processing termination determination.

FIG. 26 is a network configuration example in an example of the second embodiment.

FIG. 27 is a diagram illustrating priority in Example 2-1.

FIG. 28 is a diagram illustrating simulation conditions in Example 2-1.

FIG. 29 is a diagram illustrating results of Example 2-1.

FIG. 30 is a diagram illustrating a hardware configuration example of a device.

### DESCRIPTION OF EMBODIMENTS

Embodiments of the present invention (present embodiments) will be described below with reference to the drawings. Each of the embodiments described below is merely an example, and embodiments to which the present invention is applied are not limited to the following embodiments.

In the embodiments described below, a target whose recovery priority is to be determined is set as a “communication facility”. The communication facility may be any of a communication building, a communication device, a communication device group, and an area where communication is provided by the communication facility. The communication facility may be other than the above. The communication facility may be referred to as a facility.

Hereinafter, a first embodiment and a second embodiment will be described.

### First Embodiment: System Configuration

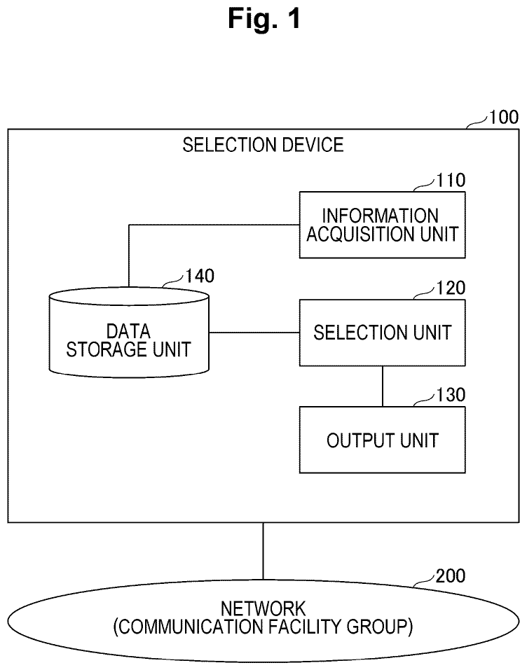

FIG. 1 illustrates an overall configuration example of a system in the present embodiment. As illustrated in FIG. 1, the system includes a selection device 100 that selects a failed facility to be preferentially recovered and a network 200. The network 200 is a network that provides a communication service and includes a plurality of communication facilities (communication facility group). Assume that the plurality of communication facilities in the present embodiment are connected in a ring shape, and that the plurality of rings have high and low levels.

The selection device 100 and the network 200 are connected by a control line or the like, and the selection device 100 can acquire information, such as the presence or absence of a failure in each communication facility, from the network 200.

As illustrated in FIG. 1, the selection device 100 includes an information acquisition unit 110, a selection unit 120, an output unit 130, and a data storage unit 140.

### First Embodiment: Operation Example of Selection Device 100

An operation example of the selection device 100 having the above configuration will be described with reference to a flowchart. A description will be made appropriately using specific examples.

### <S1, S2>

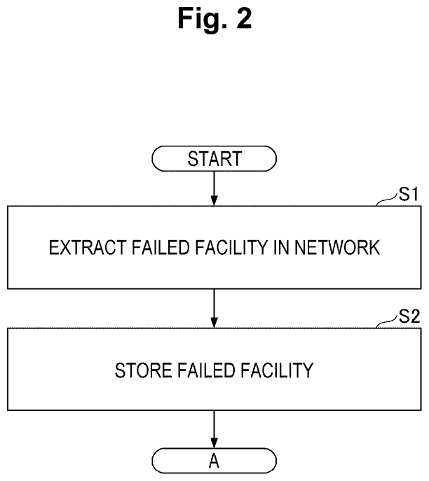

First, S1 (step 1) and S2 will be described with reference to a flowchart of FIG. 2. In S1 (step 1), the information acquisition unit 110 acquires information regarding a communication facility in which a failure has occurred due to a disaster from the network 200. Note that the communication facility in which a failure has occurred will be referred to as a failed facility.

In S2, the information acquisition unit 110 stores the information regarding the failed facility in the data storage unit 140.

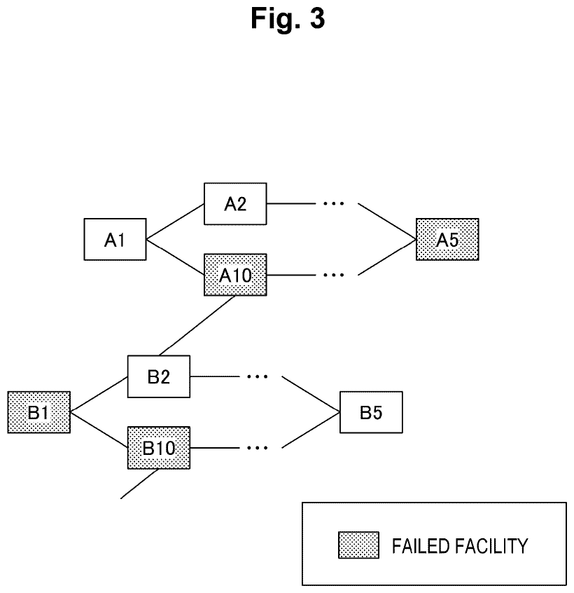

A specific example of S1 and S2 will be described with reference to FIG. 3. FIG. 3 illustrates a configuration example of the network 200 including failed facilities. In FIG. 3, “A1” and the like are symbols for identifying communication facilities. In the example of FIG. 3, the levels are distinguished by “A” and “B”. “A” is higher than “B”. In the following description, in some cases, a symbol such as A1 may be used to mean a communication facility indicated by the symbol.

In the example of FIGS. 3, A5, A10, B1, and B10 are failed facilities, and in S1, the information acquisition unit 110 acquires information regarding those failed facilities and stores the information in the data storage unit 140.

### <S3 to S8>

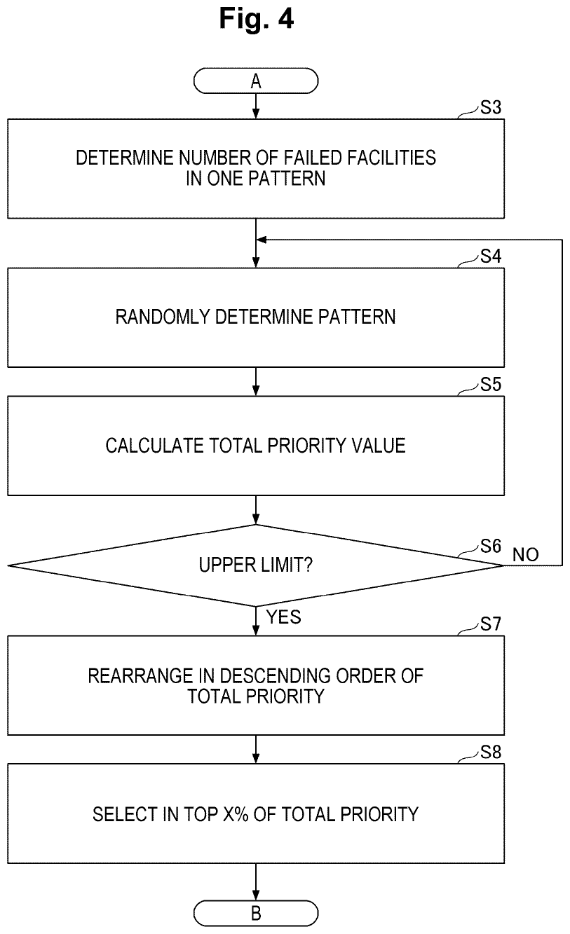

S3 to S8 will be described with reference to a flowchart of FIG. 4. In the present embodiment, a combination of a plurality of failed facilities will be referred to as a “pattern”. By regarding the “pattern” as a “gene”, an algorithm described below can be considered as a genetic algorithm. In the following description, each stage in repetitive processing will be referred to as a “generation”.

In S3, the selection unit 120 determines the number of failed facilities forming one pattern. Note that the number of failed facilities forming one pattern may be a predetermined number. Alternatively, the number of failed facilities forming one pattern may be determined according to a total number of failed facilities.

In S4, the selection unit 120 randomly determines a combination (=pattern) of failed facilities in the number determined in S3 based on the information regarding the failed facilities stored in the data storage unit 140.

In S5, the selection unit 120 calculates a total priority value of the plurality of failed facilities forming the determined pattern. The priority of a failed facility here includes an influence (ripple effect) of the failed facility on other facilities. Details thereof will be described later.

In the present embodiment, the priority is the order of priority at which recovery from a failure is to be performed, and the higher the priority, the more preferentially the recovery is performed. Further, in the present embodiment, when the priority is indicated by a numerical value, the larger the numerical value, the higher the priority.

Assume here that there is an upper limit to the number of patterns determined in S4, and, if the number of patterns does not reach the upper limit in S6, the processing returns to S4, and S4 and S5 are performed again. The selection unit 120 performs such processing until the number of patterns reaches the upper limit.

For example, assuming that the number of failed facilities forming one pattern is 3 and the failed facilities are A5, A10, B1, and B10, patterns such as “A5, A10, B1”, “A10, B1, B10”, and “A5, B1, B10” and the total priority of the failed facilities in each pattern are calculated by repeatedly performing S4 and S5.

When the number of patterns reaches the upper limit (No in S6), the processing proceeds to S7, and the selection unit 120 rearranges a set of the determined patterns in descending order of the total priority. In S8, for the patterns arranged in descending order of the total priority, the selection unit 120 retains patterns in the top X % of the total priority and eliminates patterns not in the top X %. X is a predetermined value.

In the present embodiment, “rearranging in descending order of the total priority” may be “rearranging in ascending order of the total priority”. In the case of “rearranging patterns in ascending order of the total priority”, if the patterns are selected in descending order of the total priority, it is the same as “rearranging patterns in descending order of the total priority”.

The set of patterns obtained in the flow of FIG. 4 is a set of the first-generation patterns. That is, when the generation is represented as the n-th generation, n is 1 here.

Regarding the total priority in S5, for example, the data storage unit 140 may store in advance, for each communication facility, priority including a ripple effect in a case where a failure occurs in the communication facility. In this case, the selection unit 120 acquires the priority of each failed facility from the data storage unit 140 and sums up the priority of the plurality of failed facilities in the pattern. For example, regarding the pattern of “A5, A10, B1”, assuming that the priority of A5 is 3, the priority of A10 is 5, and the priority of B1 is 1, the sum is 9. Since the ripple effect is considered, the priority of each failed facility can vary depending on the combination of the plurality of failed facilities forming the pattern.

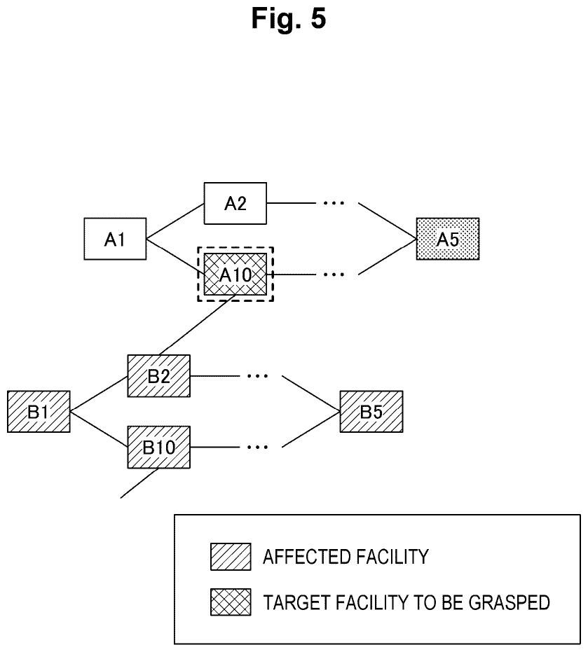

As illustrated in FIG. 5, when a failure occurs in A10, the occurrence of the failure affects facilities located below A10. From this viewpoint, for example, the selection unit 120 may calculate the priority of A10 as the sum of the degree of influence of A10 itself (e.g., the number of users affected) and the degree of influence of affected facilities (B1 to B10) (e.g., the total number of users affected by the affected facilities).

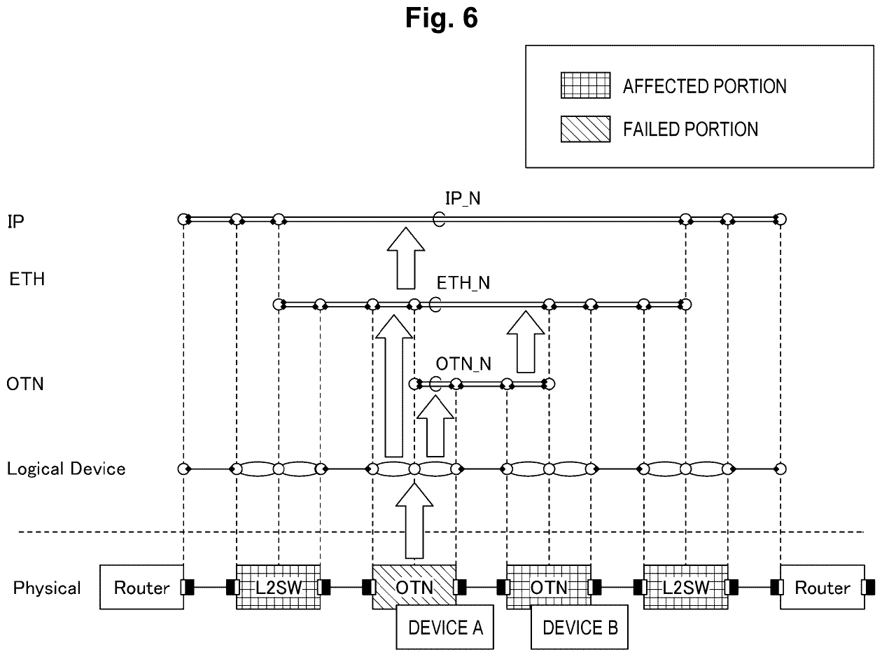

The selection unit 120 may grasp facilities affected by the failed facility by using the technique disclosed in Non Patent Literature 1 and calculate the priority based on, for example, the number of affected facilities. For example, as illustrated in FIG. 6, it is possible to grasp affected facilities based on information such as a hierarchical relationship between layers.

The example of FIG. 6 illustrates portions affected by a failure in a device A. In this case, the priority of the device A can be calculated as “the degree of influence of the failure in the device A+the degree of influence of affected portions”. If a failure also occurs in a device B, the priority of the device A is the same as described above because the device A is close to the device B.

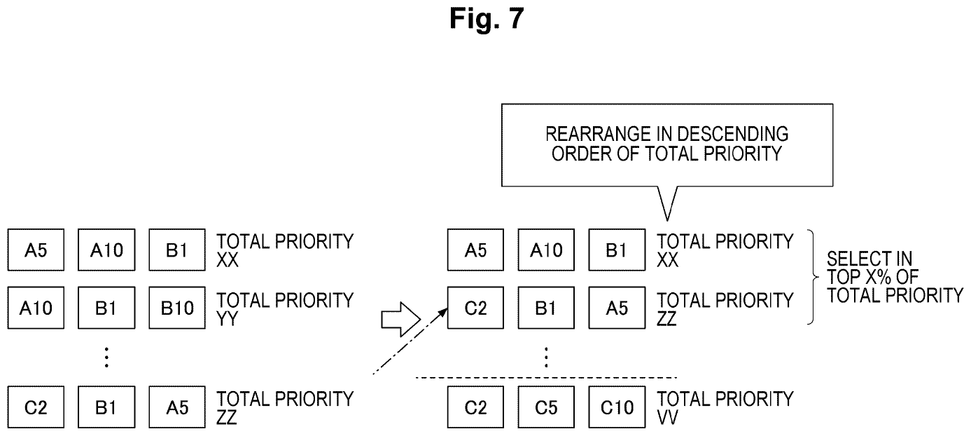

A specific example of S3 to S8 will be described with reference to FIG. 7. In the example of FIG. 7, the number of failed facilities forming one pattern is 3.

As illustrated on the left side of FIG. 7, as a result of repeating S3 to S4 until the number of patterns reaches the upper limit number, patterns of “A5, A10, B1”, “A10, B1, B10”, . . . , and “C2, B1, A5” are obtained. The total priority of each pattern is calculated.

As illustrated on the right side of FIG. 7, the set of patterns is rearranged in descending order of the total priority, and patterns in the top X % of the total priority are selected. In the example of FIG. 5, the combination (pattern) of “A5, A10, B1” has the highest total priority. The top X % is the number of patterns in the top X % among all target patterns.

In each generation, selecting patterns in the top X % of the total priority is merely an example. For example, the top Y pattern having higher total priority may be selected. Y is a predetermined integer.

### <S9 to S17>

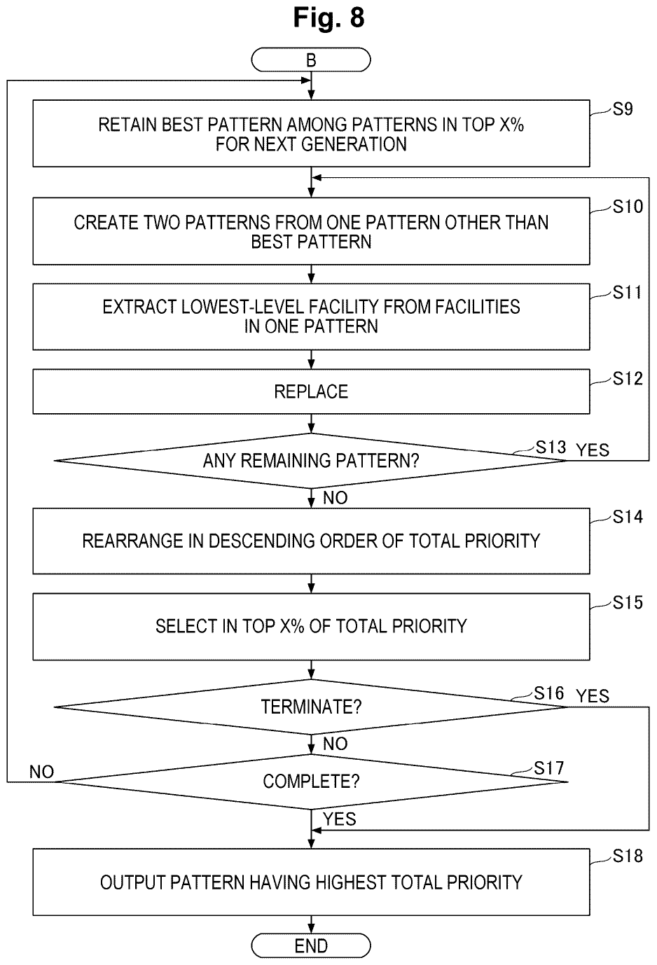

Next, S9 to S18 will be described with reference to a flowchart of FIG. 8. Here, processing of generating a set of the (n+1)-th generation patterns by processing on a set of the n-th generation patterns is repeatedly performed while the generation is caused to progress one by one.

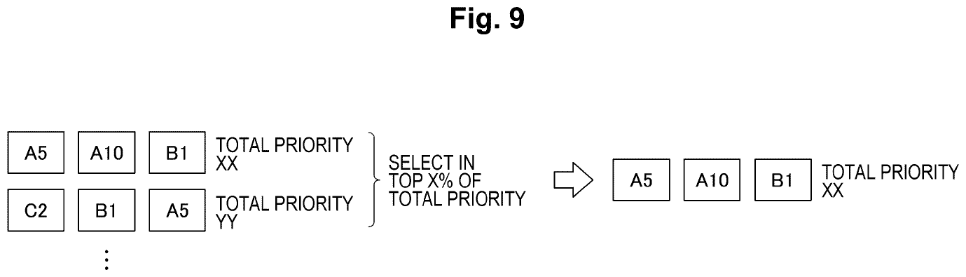

In S9, the selection unit 120 retains the pattern having the highest total priority among the patterns in the top X % in the current generation for the next generation. FIG. 9 illustrates a specific example. In the example of FIG. 9, “A5, A10, B1” has the highest priority, and thus this pattern is retained for the next generation.

In S10 of FIG. 8, the selection unit 120 selects one pattern other than the pattern having the highest total priority from the set of patterns in the current generation and generates a plurality of copies of the pattern. Here, two copies are generated. Note that generating two copies is an example, and three or more copies may be generated.

In S11, for each copy of the pattern (the pattern extracted in S10), the selection unit 120 extracts a failed facility at the lowest level from among a plurality of failed facilities forming the pattern. When there is a plurality of failed facilities at the lowest level, it is only necessary to select any one of the plurality of failed facilities.

In S12, for each copy of the pattern, the selection unit 120 replaces the failed facility at the lowest level extracted in S11 with another failed facility at a level equal to or higher than the lowest level. The selection unit 120 calculates the total priority of each pattern in which the failed facility at the lowest level has been replaced with another failed facility.

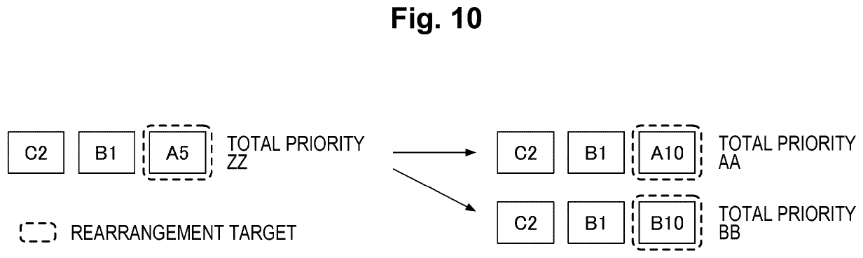

FIG. 10 illustrates a specific example of S10 to S12. In the example of FIG. 10, “C2, B1, A5” is selected, and two copies are created in S10. Among C2, B1, and A5, A5 has the lowest level.

In S11, A5 is selected as the failed facility to be replaced in each of the two copied patterns. In S12, A5 is replaced with A10 in one of the two copied patterns, and A5 is replaced with B10 in the other pattern. The selection unit 120 calculates the total priority of the two patterns “C2, B1, A10” and “C2, B1, B10” created by this processing as AA and BB, respectively.

In the flow of FIG. 8, the selection unit 120 performs the processing in S10 to S12 for each of all the patterns in the current generation (all the patterns after the selection) other than the pattern having the highest total priority. When the processing in S10 to S12 is completed for all the patterns other than the pattern having the highest total priority (No in S13), the processing proceeds to S14.

A set of patterns at the point in time when the processing proceeds to S14 includes the pattern having the highest total priority retained in S9 and the set of patterns obtained by repeating S10 to S12. The set of patterns at the point in time when the processing proceeds to S14 is a set of patterns in the next generation of the set of patterns so far.

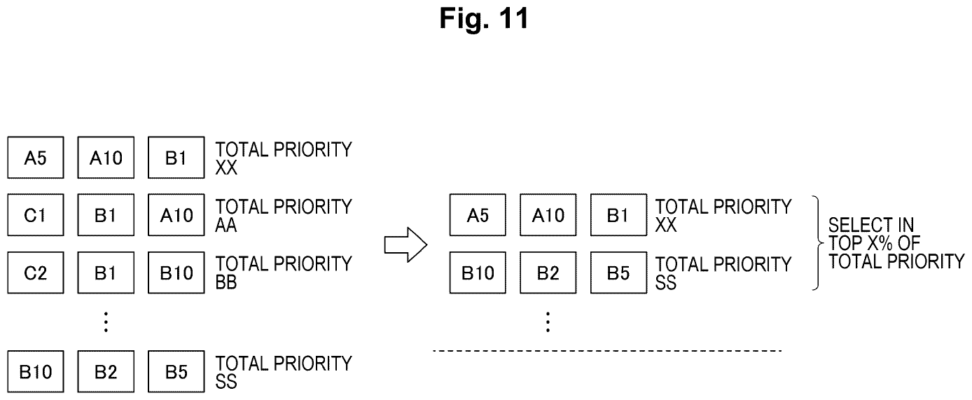

In S14, the selection unit 120 rearranges the set of patterns in descending order of the total priority, and in S15, patterns in the top X % of the total priority are selected. FIG. 11 illustrates an example of S14 and S15. The processing in S9 to S13 is performed on the set of patterns retained at this point in time, and S14 and S15 are performed on the set of patterns obtained. Such processing is repeatedly performed.

The selection unit 120 repeats the processing in S9 to S15 as described above. The processing is repeatedly performed, for example, until the number of generations reaches a predetermined number of generations. Further, when the amount of change (the amount of increase) in the highest total priority between the m-th generation and the (m+k)-th generation is equal to or less than a threshold before the number of generations reaches the predetermined number of generations while the processing is repeatedly performed until the number of generations reaches the predetermined number of generations, the repetitive processing may be terminated in the (m+k)-th generation. The symbol k represents a predetermined integer. The symbol k may be 1. The threshold may be 0.

The flow of FIG. 8 includes the above termination determination in S16. In S16, the selection unit 120 determines whether to terminate the processing by the above determination method. If the determination in S16 is Yes, the processing proceeds to S18, and if the determination is No, the processing proceeds to S17. Regarding the determination as to whether to terminate the processing, the processing may be terminated when the number of generations reaches the predetermined number of generations.

In S17, the selection unit 120 determines whether the number of generations has reached the predetermined number of generations. If the determination is Yes, the processing proceeds to S18, and if the determination is No, the processing returns to S9. Assuming that the predetermined number of generations for completion is 50 as an example, the determination in S17 is Yes when the current generation becomes the 50th generation.

In S18, the selection unit 120 passes, to the output unit 130, the pattern having the highest total priority in the set of patterns in the current generation. The output unit 130 outputs that pattern. Regarding the output, the top Z patterns having higher total priority may be output in the set of patterns in the current generation. Z is a predetermined integer.

The failed facilities in the pattern output from the output unit 130 are failed facilities to be preferentially recovered.

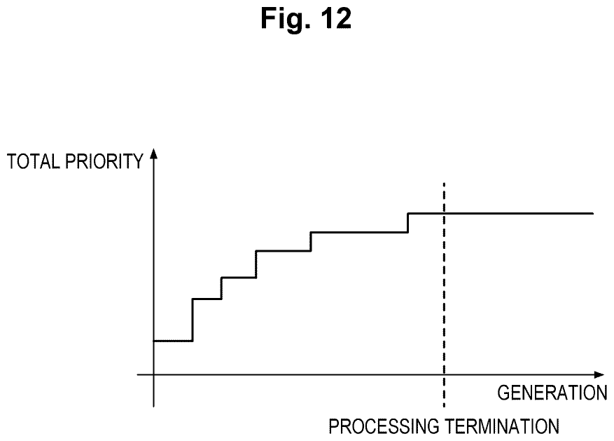

FIG. 12 illustrates a state where the highest total priority increases as the generation progresses according to the flow of FIG. 8. FIG. 12 also illustrates an example where the processing is terminated at the midpoint. As illustrated in FIG. 12, in the processing of the flow in FIG. 8, patterns having high total priority are frequently found in the early generation, but the total priority is not updated in the later generation.

Hereinafter, specific processing examples (simulations) by the selection device 100 will be described as examples. Example 1-1 and Example 1-2 of the first embodiment will be described below.

### First Embodiment: Example 1-1

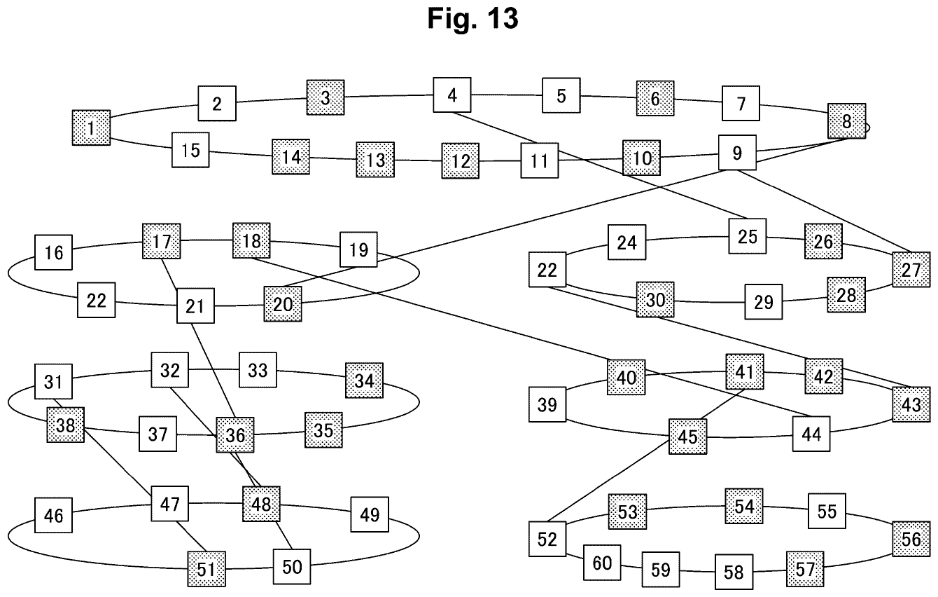

FIG. 13 illustrates the configuration of the network 200 in Example 1-1. Each square in FIG. 13 indicates a facility, and shaded squares indicate failed facilities. Each facility is numbered, and hereinafter, each facility will be referred to using the number.

As illustrated in FIG. 13, the network 200 has a hierarchical structure in which a lower-level ring is connected to a higher-level ring. In Example 1-1, the priority of a facility belonging to a higher-level ring is higher than the priority of a facility belonging to a lower-level ring.

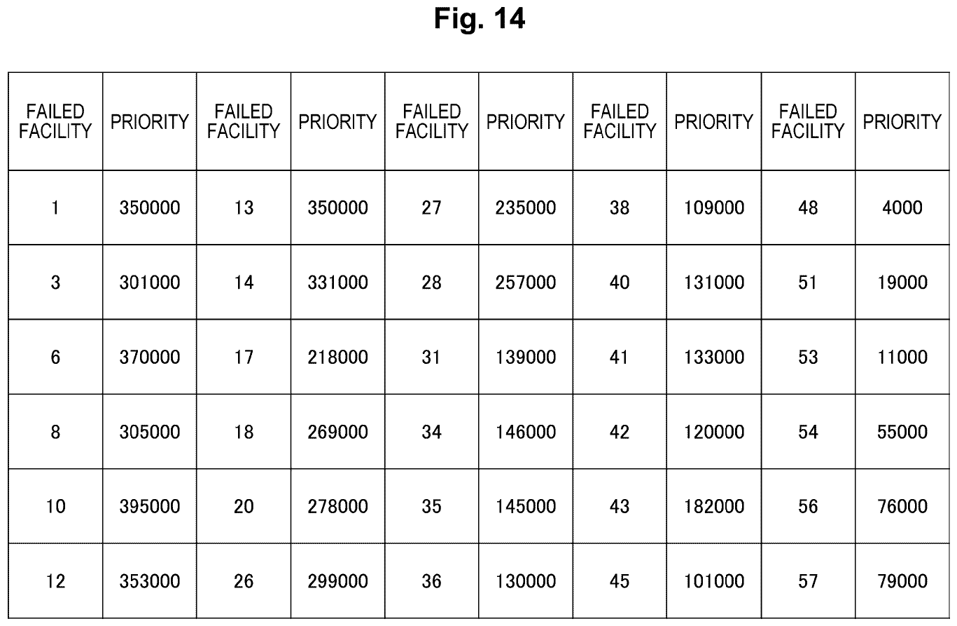

FIG. 14 illustrates an example of failed facilities and information regarding the priority thereof acquired from the information acquisition unit 110 and stored in the data storage unit 140. In the present example, the priority is set to only the failed facilities to make the effects easier to understand.

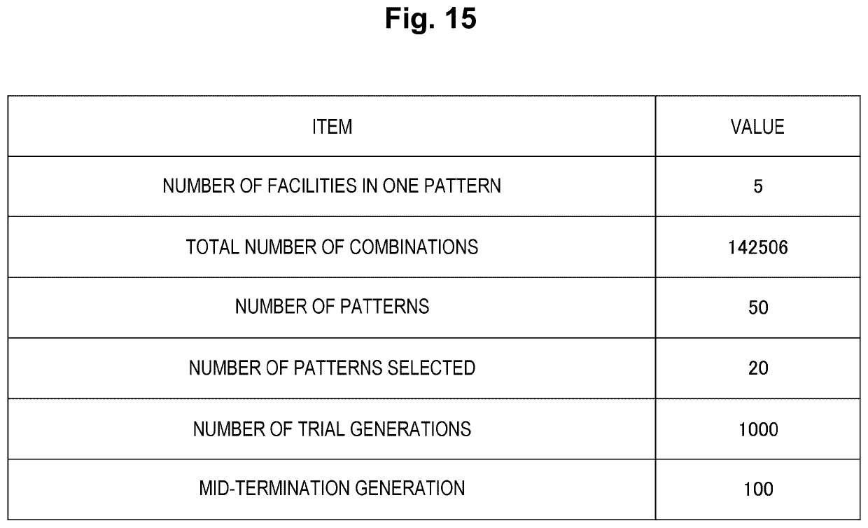

FIG. 15 illustrates simulation conditions in Example 1-1. As illustrated in FIG. 15, the number of failed facilities in one pattern is set to 5. The total number of combinations obtained by selecting five failed facilities from the 30 total failed facilities is 142, 506. The initial (first generation) number of patterns is set to 50, and the number of patterns selected is set to 20. The number of trial generations is set to 1,000 generations. The number of generations when the processing is terminated in the middle is set to 100 generations.

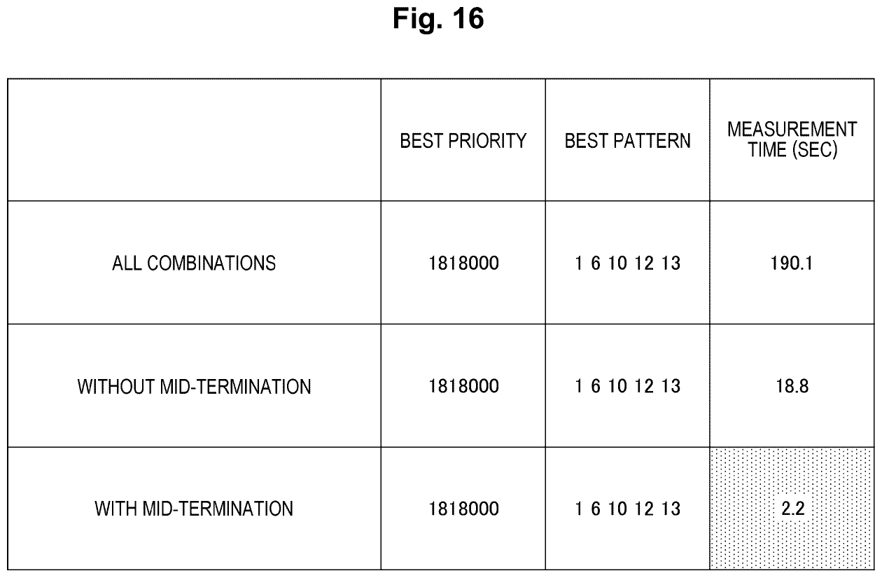

FIG. 16 illustrates results of calculation performed by the selection device 100 under the above conditions. As illustrated in FIG. 16, it is possible to perform calculation at a high speed by using the algorithm according to the present embodiment as compared with a case where calculation is performed in all combinations.

### First Embodiment: Example 1-2

Next, Example 1-2 will be described. The configuration of the network 200 in Example 1-2 is the same as that of Example 1-1 and is as illustrated in FIG. 13.

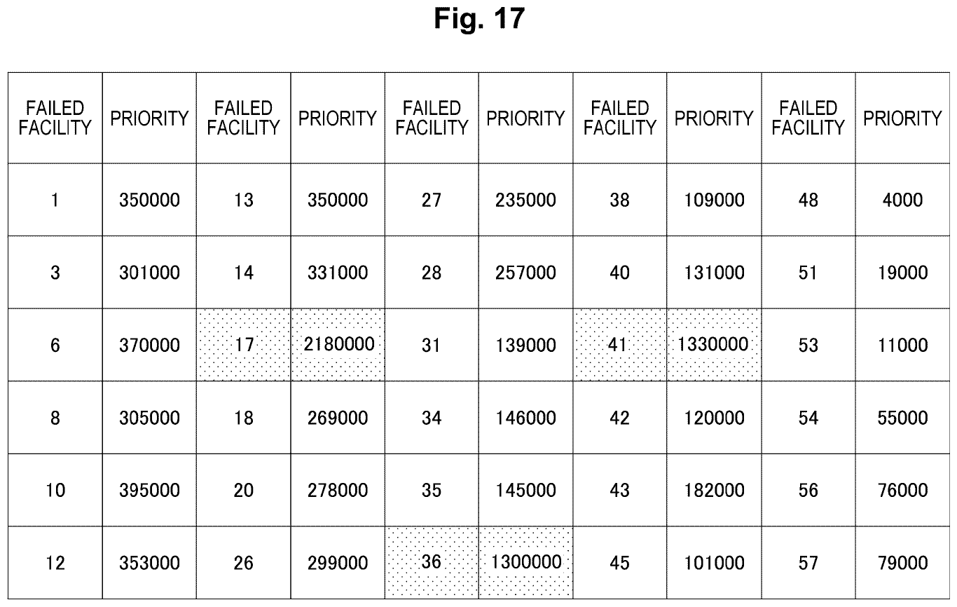

FIG. 17 illustrates an example of failed facilities and information regarding the priority thereof acquired from the information acquisition unit 110 and stored in the data storage unit 140. In the present example as well, the priority is set to only the failed facilities to make the effects easier to understand.

In Example 1-2, in some cases, the priority of a facility belonging to a lower-level ring is higher than the priority of a facility belonging to a higher-level ring due to a network (NW) configuration or the like. The above facilities correspond to 17, 36, and 41 in FIG. 17.

Simulation conditions in Example 1-2 are the same as those in Example 1 and are as illustrated in FIG. 15.

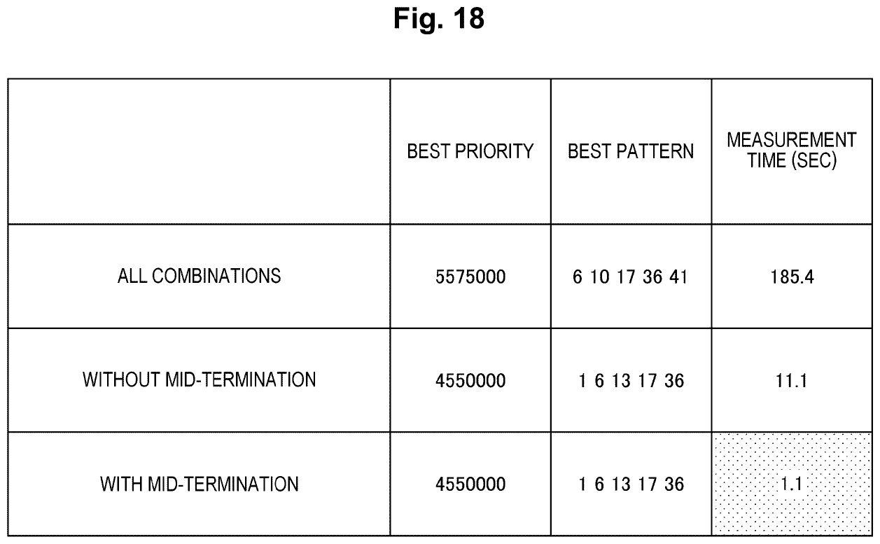

FIG. 18 illustrates results of calculation performed by the selection device 100 under the above conditions. As illustrated in FIG. 18, it is possible to perform calculation at a high speed by using the algorithm according to the present embodiment as compared with a case where calculation is performed in all combinations. In Example 2-1, When the algorithm according to the present embodiment is used, the total priority obtained is lower than the total priority of the best pattern obtained by calculation of all combinations, but a difference therebetween is small. Thus, it can be seen that the algorithm according to the present embodiment is effective.

### Second Embodiment

Next, a second embodiment will be described. The basic processing flow (specifically, the flow of processing of the genetic algorithm) in the second embodiment is the same as that in the first embodiment. Hereinafter, differences from the first embodiment will be mainly described.

In a case where the recovery priority (total priority) is checked for all the combination patterns of the plurality of failed facilities in the network, a long calculation time is required because the number of patterns is large.

Therefore, in the technique described in the first embodiment, the genetic algorithm of the procedure illustrated in FIGS. 2, 4, and 8 was used to search for a pattern having high total priority by performing repetitive processing while rearranging the patterns.

In the technique described in the first embodiment, increasing the number of generations (the number of times of repetitive processing) enables the calculation of a good pattern having high total priority but leads to an increase in calculation time.” In addition, if the number of generations is reduced to shorten the calculation time, obtaining a good pattern becomes difficult.

In the first embodiment, as described with reference to FIG. 12 and the like, it is possible to use a method of terminating the generation progress in the middle of the repetitive processing (referred to as a processing termination method, which may be referred to as an annealing method).

However, in the first embodiment, when the processing termination method is used, the processing may not necessarily be terminated the optimal number of times (the number of times in which processing time is short and high total priority is obtained).

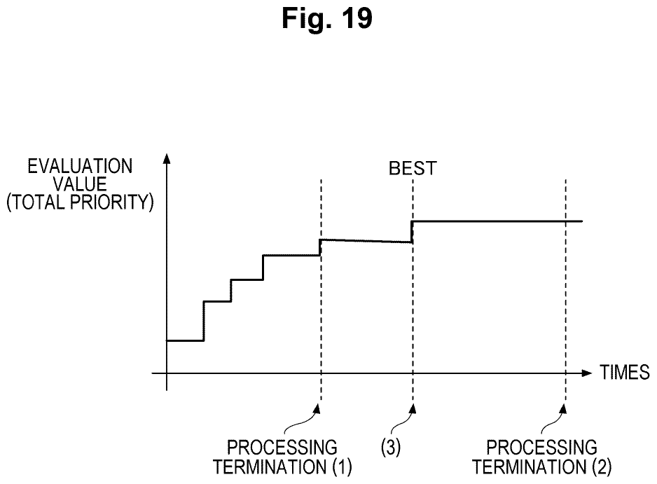

For example, as illustrated in FIG. 19, if the processing is terminated at the point of the number of times indicated by (1), the processing time is short, but the total priority increases with further generation progress. Therefore, the point in time indicated by (1) is too early as the point in time for processing termination. If the processing is terminated at the point in time indicated by (2) of FIG. 19, the pattern having the highest total priority can be obtained, but the processing time becomes long.

It is best to terminate the processing at the point in time indicated by (3) illustrated in FIG. 19. However, in the first embodiment, there is no mechanism for grasping the best number of times at termination. Therefore, in the second embodiment, the selection device 100 determines a reference value for determining the optimal number of times (the number of generations) at termination by preliminary learning, and terminates the processing based on the reference value when selecting a failed facility to be preferentially recovered. Hereinafter, a device configuration and a device operation of the second embodiment will be described in detail.

### Second Embodiment: Device Configuration

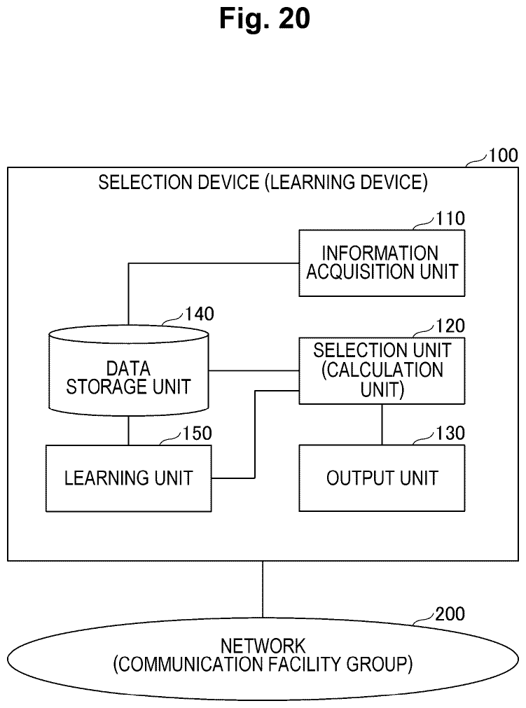

FIG. 20 illustrates a configuration example of a selection device 100 in the second embodiment. As illustrated in FIG. 20, the selection device 100 in the second embodiment has a configuration in which a learning unit 150 is added to the selection device 100 (FIG. 1) in the first embodiment. The learning unit 150 executes preliminary learning for grasping the optimal number of times at termination.

Note that a learning device for obtaining a reference value may be provided separately from the selection device 100 that selects a failed facility to be preferentially recovered. The configuration of the learning device in that case is similar to the configuration illustrated in FIG. 20. In the learning device, a functional unit that executes repetitive processing may be referred to as a calculation unit.

### Second Embodiment: Device Operation

Next, the operation of the selection device 100 in the second embodiment will be described.

### Second Embodiment: Preliminary Learning

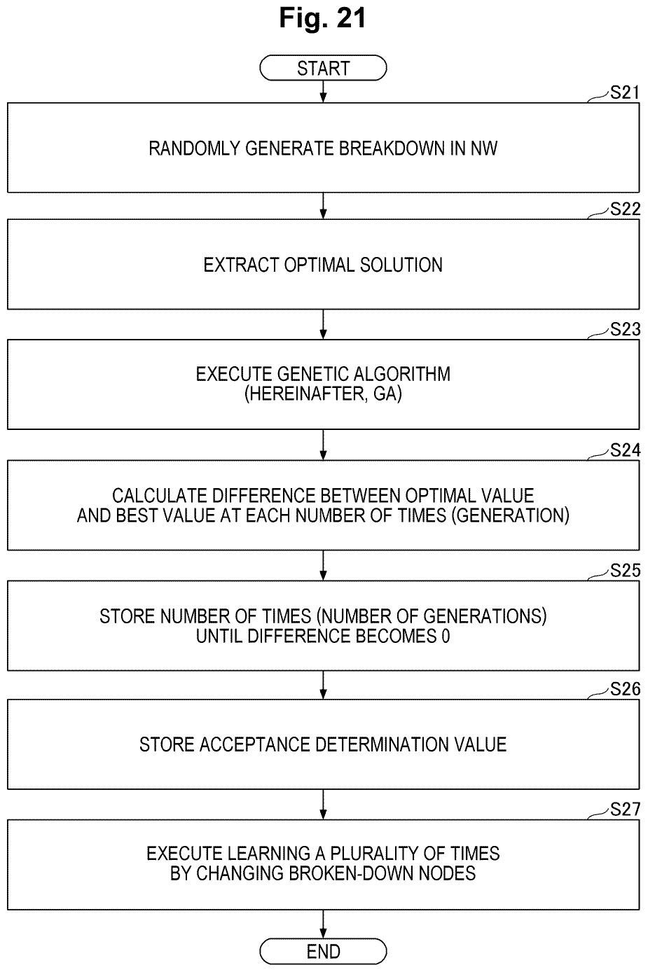

First, the operation during preliminary learning will be described along the procedure of the flowchart of FIG. 21.

### <S21>

In S21, a breakdown is randomly generated in the target network 200. In generating a breakdown, a breakdown may not be generated in the actual network 200, but may be generated on a computer that has the configuration data of the network.

Information regarding a failed facility caused by the occurrence of a breakdown is acquired by the information acquisition unit 110 and stored in the data storage unit 140.

### <S22>

In S22, the selection unit 120 calculates the total priority for each of all combinations (patterns) of the failed facilities, thereby extracting the optimal solution (the pattern having the highest total priority). The total priority in the pattern having the highest total priority is referred to as an “optimal value”. The total priority of the pattern having the highest total priority may be referred to as an “optimal solution”.

### <S23>

In S23, the selection unit 120 executes a genetic algorithm (the procedure illustrated in FIGS. 2, 4, and 8). In some cases, the genetic algorithm may be referred to as “GA” in the following description of the flow.

### <S24>

In S24, the learning unit 150 calculates a difference between the optimal value obtained in S22 and the best value (the total priority of the pattern having the best total priority) in GA at each number of times (each generation).

### <S25>

In S25, the learning unit 150 stores in the data storage unit 140 the number of times (the number of generations) until the difference calculated in S24 becomes 0. The number of times until the difference becomes 0 may be the number of times until the difference first becomes 0.

### <S26>

In S26, the learning unit 150 calculates an acceptance determination value by using the evaluation value (the best value of the total priority) at the number of times (the number of generations) until the difference from the optimal solution becomes 0 and the evaluation value of the generation one time before, and stores the acceptance determination value in the data storage unit 140. The learning unit 150 may calculate the acceptance determination value by using the evaluation value one time before the number of times (the number of generations) until the difference from the optimal solution becomes 0 and the evaluation value of the generation one time before.

### <S27>

The selection device 100 executes the processing of S21 to S26 a plurality of times. That is, the processing of S22 to S26 is repeatedly executed a plurality of times by changing broken-down nodes (failed facilities).

### <Result of Preliminary Learning>

Based on the value obtained in the above processing, the learning unit 150 obtains, for each number of broken-down nodes on the NW, a minimum value of the number of times until the optimal value is obtained, an average value of the number of times until the optimal value is obtained, and the acceptance determination value when the optimal value is obtained. These values may be referred to as reference values. The reference values are stored in the data storage unit 140. Note that the minimum value and the average value are examples of statistical values. The learning unit 150 may calculate a statistical value other than the “minimum value/average value” of the number of times until the optimal value is obtained, as the reference value.

### Second Embodiment: Specific Description of Preliminary Learning

Main operations in the flow of the preliminary learning described above will be described more specifically.

As described in S24 and S25, the learning unit 150 calculates the difference between the optimal value obtained in S22 and the best value (which may be referred to as an approximate solution) in GA, and stores the number of times until the difference becomes 0. Such calculation is performed a plurality of times by randomly changing broken-down nodes.

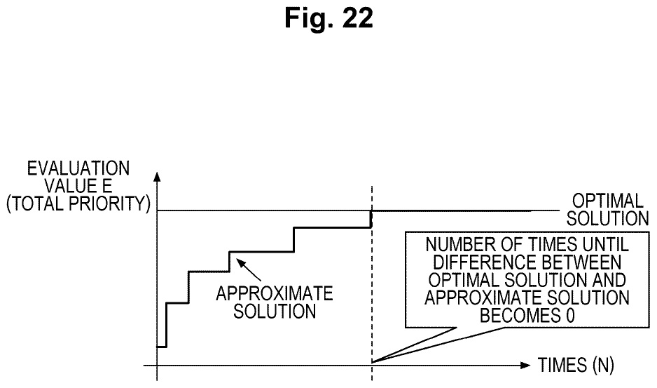

FIG. 22 is a diagram illustrating a state where the difference between the optimal solution and the approximate solution becomes 0. As illustrated in FIG. 22, as the generation progresses, the value of the approximate solution gradually increases, and the difference between the optimal value and the approximate solution becomes 0.

As a result of performing a plurality of calculations by randomly changing broken-down nodes, the learning unit 150 obtains a plurality of number of times until the difference between the optimal solution and the approximate solution becomes 0. The learning unit 150 uses this result to calculate a minimum value (X times) and an average value (Y times) of the number of times until the difference between the optimal solution and the approximate solution becomes 0 in a case where M nodes are broken down in the target network, for example, and stores the calculation result in the data storage unit 140. Since the number of broken-down nodes can vary, the data storage unit 140 stores a minimum value (X times) and an average value (Y times) for each number M of broken-down nodes.

Next, the acceptance determination value in S26 will be described. The acceptance determination value in the present embodiment is a value used for acceptance determination in the Simulated Annealing method (annealing method), and the learning unit 150 calculates the acceptance determination value by the following formula.

“Acceptance determination value=1” (case of ΔE>0), “acceptance determination value=exp(−ΔΕ/N)” (case other than (ΔΕ>0))

In the above formulas, N corresponds to the number of times n at the time of calculating ΔE. “ΔE=E(n−1)−E(n)”. E(n−1) is an evaluation value (the best value of the total priority) at the number of times n−1, and E(n) is an evaluation value at the number of times n.

Since “−ΔE/N” approaches 0 as the number of times N increases, “acceptance determination value=exp (−ΔE/N)” approaches 1 as the number of times N increases.

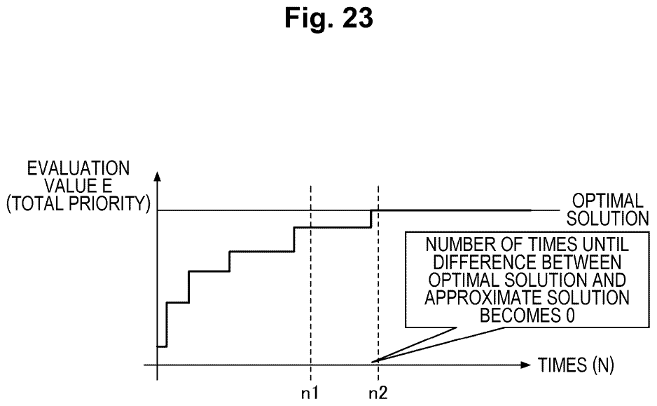

An example of the acceptance determination value will be described with reference to FIG. 23. In FIG. 23, for example, the acceptance determination value when the number of times is n1 is 0.85. The acceptance determination value when the number of times is n2 (the number of times until the difference becomes 0) is 0.93, which is the value calculated using the evaluation value at n2 and the evaluation value from one time before. That is, in this case, the learning unit 150 calculates 0.93 as an acceptance determination value (which may also be referred to as an acceptance value) and stores the acceptance determination value in the data storage unit 140.

For example, assuming that the number of broken-down nodes when the acceptance determination value=0.93 is calculated is M, the acceptance determination value=0.93 can be used in the processing termination determination when the number of broken-down nodes is M in the genetic algorithm as described later.

Since the above processing is performed by randomly changing broken-down nodes, it is possible to obtain acceptance determination values corresponding to various M values. When a plurality of acceptance determination values is obtained for the same M, for example, an average of the plurality of acceptance determination values may be used as the acceptance determination value of the M.

### Second Embodiment: Execution of Genetic Algorithm

In the second embodiment, in the execution of the genetic algorithm, the processing termination determination is performed using the result (reference value) of the preliminary learning described above.

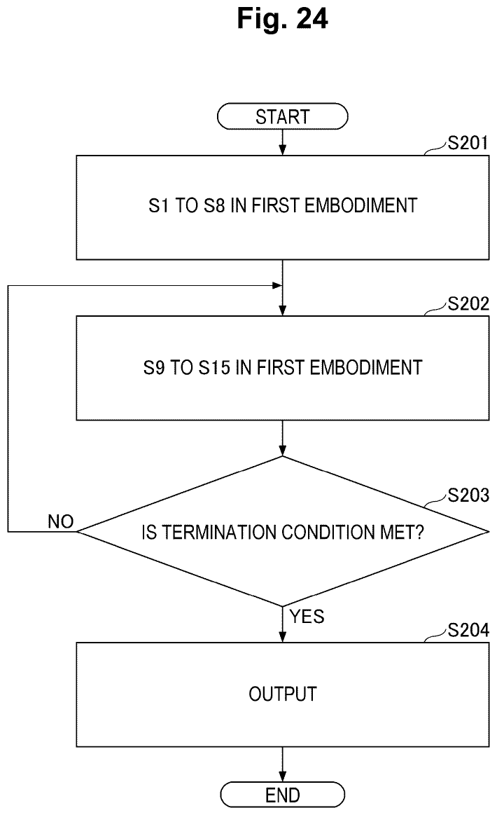

Processing for extracting the pattern having the highest total priority (processing using the genetic algorithm) in the second embodiment will be described with reference to FIG. 24.

Assume here that, as a result of preliminary learning, when the number of broken-down nodes is M, Z is obtained as an acceptance determination value, X is obtained as a minimum value of “the number of times until the difference between the optimal solution and the approximate solution becomes 0”, and Y is obtained as an average value of “the number of times until the difference between the optimal solution and the approximate solution becomes 0”.

In S201, the selection device 100 executes S1 to S8 described in the first embodiment. Assume here that the number of broken-down nodes (failed facilities) in the network 200 is M.

In S202, the selection device 100 executes S9 to S15 described in the first embodiment.

In the first embodiment, for example, the processing of S9 to S15 has been repeatedly performed until the number of generations reaches a predetermined number of generations.

On the other hand, in the second embodiment, in S203, the selection unit 120 determines whether the pattern of the generation that has been obtained at the stage of S15 (the highest total priority) meets the condition for terminating the processing by using the results (Z, X, Y, etc.) obtained by preliminary learning. That is, the determination in S203 is performed every time the generation advances by one.

If the determination result in S203 is Yes, the selection unit 120 terminates the processing at this point in time, and in S204, the output unit 130 outputs the pattern having the highest total priority in the set of patterns of the generation at the point in time when the processing is terminated. If the determination result in S203 is No, S9 to S15 are executed in the next generation.

### <S203: Specific Example of Processing Termination Determination>

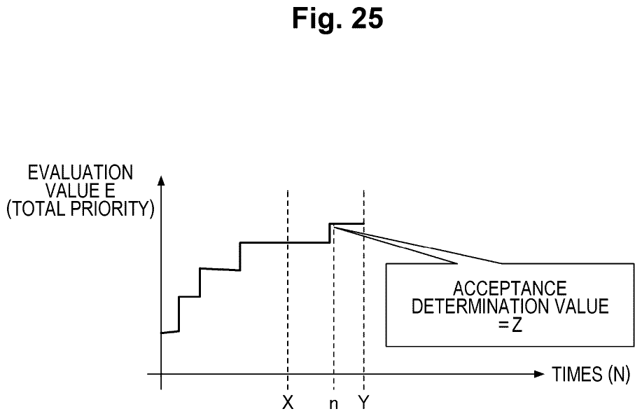

A specific example of determination of termination of processing in S203 will be described. FIG. 25 is a diagram for describing a method for determining processing termination. Assume that in FIG. 25, the number of times (the number of generations) at the point in time for determining whether to terminate is n. Z, X, and Y are respectively an acceptance determination value, a minimum value of “the number of times until the difference between the optimal solution and the approximate solution becomes 0”, and an average value of “the number of times until the difference between the optimal solution and the approximate solution becomes 0”, obtained by preliminary learning.

The selection unit 120 determines whether to terminate the processing using, for example, any one of the following conditions 1 to 8. That is, if the selection unit 120 determines that the condition is met, the generation progress processing is terminated. Which one of conditions 1 to 8 is used can be set in advance.

In the following description, “A exceeds B” may be defined as “A is equal to or greater than B”. In addition, “A is equal to or less than B” may be defined as “A is less than B”. In a case where “the acceptance determination value at the point of the number of times n exceeds Z” is used, “the acceptance determination value at the point of the number of times n exceeds Z” may mean that “at the point of the number of times n, the acceptance determination value has exceeded Z a predetermined number of times”. Note that the method of calculating the acceptance determination value at the point of the number of times n is as described above.

### <Condition 1>

The number of times n exceeds the minimum value X.

### <Condition 2>

“(The number of times n exceeds the minimum value X) and (the number of times n is equal to or less than the average value Y)”.

### <Condition 3>

The acceptance determination value at the point of the number of times n exceeds Z.

### <Condition 4>

“(The number of times n exceeds the minimum value X) and (the acceptance determination value at the point of the number of times n exceeds Z)”.

### <Condition 5>

“(The acceptance determination value at the point of the number of times n exceeds Z) and (the number of times n is equal to or less than the average value Y)”.

### <Condition 6>

“(The acceptance determination value at the point of the number of times n exceeds Z) and (the number of times n exceeds the minimum value X) and (the number of times n is equal to or less than the average value Y)”.

### <Condition 7>

The number of times n exceeds the average value Y.

### <Condition 8>

“(The number of times n exceeds the average value Y) and (the acceptance determination value at the point of the number of times n exceeds Z)”.

Next, a specific processing example (simulation) by the selection device 100 in the second embodiment will be described as Example 2-1.

### Second Embodiment: Example 2-1

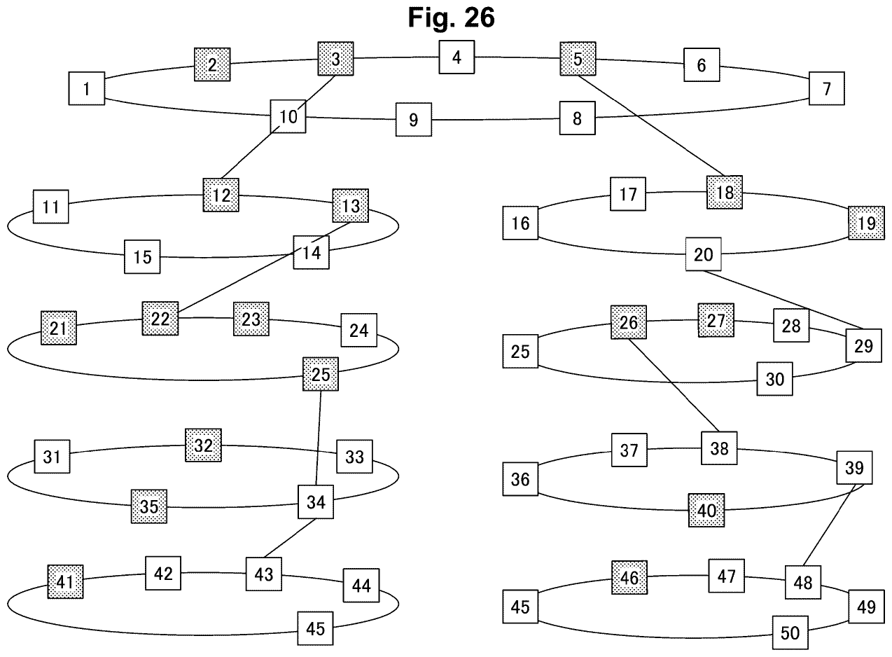

FIG. 26 illustrates the configuration of the network 200 according to Example 1. Squares in FIG. 26 indicate facilities, and shaded squares indicate failed facilities. Each facility is numbered, and hereinafter, each facility will be referred to using the number.

As illustrated in FIG. 26, the network 200 has a hierarchical structure in which a lower-level ring is connected to a higher-level ring. In Example 2-1, the priority of a facility belonging to a higher-level ring is higher than the priority of a facility belonging to a lower-level ring. In addition, the priority takes into account a ripple effect between facilities.

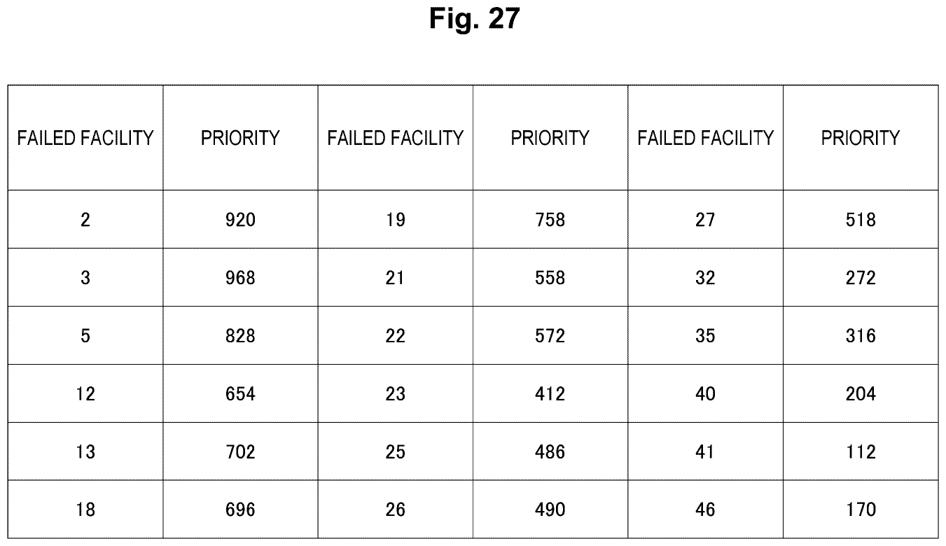

FIG. 27 illustrates an example of failed facilities and information regarding the priority thereof acquired from the information acquisition unit 110 and stored in the data storage unit 140.

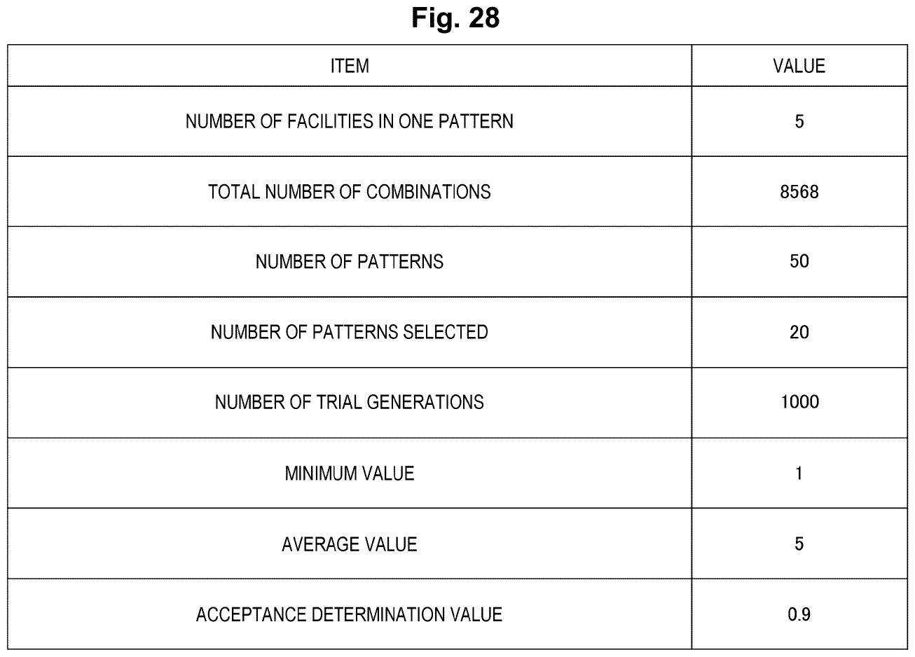

FIG. 28 illustrates simulation conditions in Example 2-1. As illustrated in FIG. 28, the number of failed facilities in one pattern is set to 5. The total number of combinations for selecting five failed facilities from the 18 total failed facilities is 8,568. The initial (first generation) number of patterns is set to 50, and the number of patterns selected is set to 20. The number of trial generations in the case of performing the processing in the first embodiment is set to 1,000 generations. The minimum value (corresponding to X described above) in preliminary learning is 1, the average value (corresponding to Y described above) in preliminary learning is 5, and the acceptance determination value (corresponding to Z described above) in preliminary learning is 0.9.

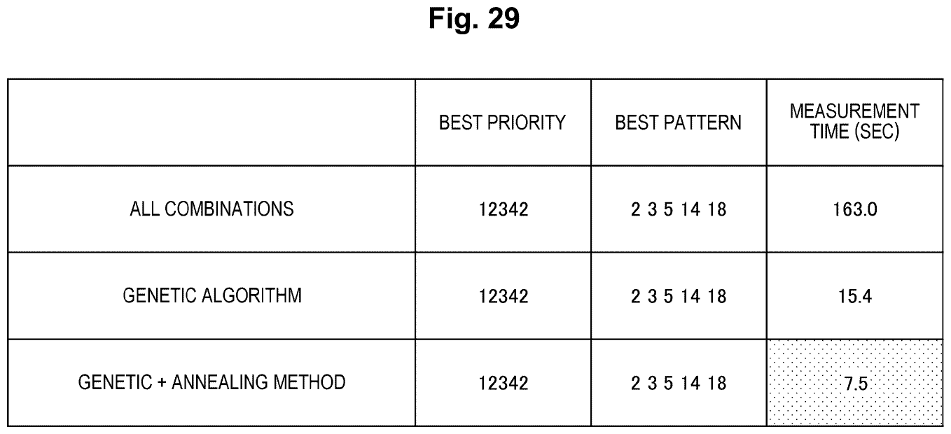

FIG. 29 illustrates results of calculation performed by the selection device 100 under the above conditions. In FIG. 29, “GENETIC ALGORITHM” means that the calculation in the first embodiment is performed by the number of trial generations. “GENETIC+ANNEALING METHOD” means that the calculation in the second embodiment is performed. As illustrated in FIG. 29, it is possible to perform calculation at a high speed by using the genetic algorithm as compared with a case where calculation is performed in all combinations. In particular, it can be seen that calculation can be performed faster by using the “genetic+annealing method”.

### Hardware Configuration Example

Both the selection device 100 and the learning device described in the present embodiment can be implemented, for example, by causing a computer to execute a program. This computer may be a physical computer or may be a virtual machine on a cloud. Hereinafter, the selection device 100 and the learning device are collectively referred to as a “device”.

That is, the device can be implemented by executing a program corresponding to processing performed in the device using a hardware resource such as a computer processing unit (CPU) and a memory built into the computer. The above program can be stored and distributed by being recorded in a computer-readable recording medium (portable memory, etc.). In addition, the above program can also be provided through a network such as the Internet or an electronic mail.

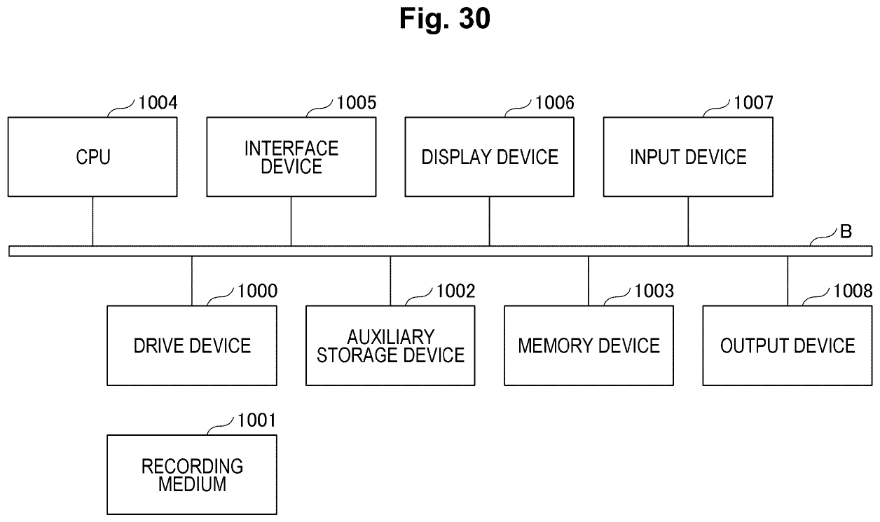

FIG. 30 illustrates a hardware configuration example of the computer. The computer in FIG. 30 includes a drive device 1000, an auxiliary storage device 1002, a memory device 1003, a CPU 1004, an interface device 1005, a display device 1006, an input device 1007, an output device 1008, and the like, which are connected to each other by a bus BS. Note that the computer may further include a graphics processing unit (GPU).

The program for implementing the processing in the computer is provided by a recording medium 1001 such as a compact disc read-only memory (CD-ROM) or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program, and also stores necessary files, data, and the like.

In a case where an instruction is given to activate the program, the memory device 1003 reads the program from the auxiliary storage device 1002 and stores the program. The CPU 1004 implements a function related to the device according to the program stored in the memory device 1003. The interface device 1005 is used as an interface for connecting to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs a calculation result.

### Effects of Embodiment

As described above, according to the technique described in the first and second embodiments, when a failure occurs in a plurality of communication facilities in a network, it is possible to quickly determine a communication facility to be recovered and thus to reduce a time until a communication service is recovered.

Further, as described in the second embodiment, in addition to the genetic algorithm, by performing processing termination determination (annealing method, etc.) based on the reference value determined by preliminary learning, it is possible to further shorten the time until the recovery of the communication service.

Regarding the above embodiment, the following Supplementary Notes 1 and 2 are further disclosed.

### SUPPLEMENTARY NOTE 1

### Supplementary Note 1

A selection device that selects a specific plurality of failed facilities to be preferentially recovered from among a plurality of failed facilities generated in a network that provides a communication service and includes a plurality of facilities, the selection device including:
a memory; and
at least one processor connected to the memory, in which
the processor
acquires information regarding the failed facilities in the network, and
extracts a plurality of patterns including a specific number of failed facilities from the plurality of failed facilities and selects the specific plurality of failed facilities based on total priority of the specific number of failed facilities in each pattern.

### Supplementary Note 2

The selection device according to supplementary note 1, in which
the processor extracts a pattern having the highest total priority from a set of first patterns and repeats processing of generating a set of third patterns from a set of second patterns including a set of patterns obtained by generating a plurality of patterns from each pattern in a set of patterns excluding the pattern having the highest total priority from the set of first patterns and the pattern having the highest total priority while regarding the set of third patterns as a new set of first patterns.

### Supplementary Note 3

The selection device according to supplementary note 2, in which
the processor rearranges the set of second patterns in order of magnitude of the total priority of each pattern and defines a set of patterns having higher total priority in the rearranged set of patterns as the set of third patterns.

### Supplementary Note 4

The selection device according to supplementary note 2, in which
the processor generates the plurality of patterns by generating a plurality of copies of each pattern in the set of patterns excluding the pattern having the highest total priority from the set of first patterns and replacing a failed facility at the lowest level in each copy with a failed facility at a level equal to or higher than the level.

### Supplementary Note 5

The selection device according to supplementary note 3, in which
the processor selects, as the specific plurality of failed facilities, failed facilities belonging to the pattern having the highest total priority in the set of third patterns after the processing is performed a plurality of times.

### Supplementary Note 6

The selection device according to any one of supplementary notes 1 to 5, in which the processor calculates priority in consideration of a ripple effect on other facilities as priority of each of the specific number of failed facilities.

### Supplementary Note 7

A selection method performed by a selection device that selects a specific plurality of failed facilities to be preferentially recovered from among a plurality of failed facilities generated in a network that provides a communication service and includes a plurality of facilities, the selection method including:

an information acquisition step of acquiring information regarding the failed facilities in the network; and
a selection step of extracting a plurality of patterns including a specific number of failed facilities from the plurality of failed facilities and selecting the specific plurality of failed facilities based on total priority of the specific number of failed facilities in each pattern.

### Supplementary Note 8

A non-transitory storage medium storing a program for causing a computer to function as each unit of the selection device according to any one of supplementary notes 1 to 6.

### SUPPLEMENTARY NOTE 2

### Supplementary Note 1

A learning device that determines a reference value used to select a specific plurality of failed facilities to be preferentially recovered from among a plurality of failed facilities generated in a network that provides a communication service and includes a plurality of facilities, the learning device including:
a memory; and
at least one processor connected to the memory, in which
the processor
executes processing of calculating total priority of a pattern including a specific number of failed facilities while replacing a failed facility in the pattern, and
determines the reference value based on a difference between an approximate solution obtained by the processing executed by the calculation unit and an optimal solution.

### Supplementary Note 2

The learning device according to supplementary note 1, in which
the processor determines, as the reference value, a minimum value or an average value of the number of times the processing is executed until the difference becomes 0.

### Supplementary Note 3

The learning device according to supplementary note 1 or 2, in which
the processor calculates an acceptance determination value based on total priority at a point in time when the difference becomes 0 and total priority in the processing one before the point in time, and determines the acceptance determination value as the reference value.

### Supplementary Note 4

A selection device that selects a specific plurality of failed facilities to be preferentially recovered from among a plurality of failed facilities generated in a network that provides a communication service and includes a plurality of facilities, the selection device including:
a memory; and
at least one processor connected to the memory, in which
the processor
acquires information regarding the failed facilities in the network, and
executes processing of calculating total priority of a pattern including a specific number of failed facilities while replacing a failed facility in the pattern, terminates the processing based on a reference value obtained by preliminary learning, and selects the specific plurality of failed facilities based on the pattern at a point in time when the processing is terminated.

### Supplementary Note 5

A learning method executed by a learning device that determines a reference value used to select a specific plurality of failed facilities to be preferentially recovered from among a plurality of failed facilities generated in a network that provides a communication service and includes a plurality of facilities, the learning method including:

a calculation step of executing processing of calculating total priority of a pattern including a specific number of failed facilities while replacing a failed facility in the pattern; and
a learning step of determining the reference value based on a difference between an approximate solution obtained by the processing executed by the calculation unit and an optimal solution.

### Supplementary Note 6

A selection method executed by a selection device that selects a specific plurality of failed facilities to be preferentially recovered from among a plurality of failed facilities generated in a network that provides a communication service and includes a plurality of facilities, the selection method including:
an information acquisition step of acquiring information regarding the failed facilities in the network; and
a selection step of executing processing of calculating total priority of a pattern including a specific number of failed facilities while replacing a failed facility in the pattern, terminating the processing based on a reference value obtained by preliminary learning, and selecting the specific plurality of failed facilities based on the pattern at a point in time when the processing is terminated.

### Supplementary Note 7

A non-transitory storage medium storing a program for causing a computer to function as each unit in the learning device according to any one of supplementary notes 1 to 3.

### Supplementary Note 8

A non-transitory storage medium storing a program for causing a computer to function as each unit in the selection device according to supplementary note 4.

Although the present embodiments have been described above, the present inventions are not limited to the specific embodiments, and various modifications and changes can be made within the scope of accompanying claims.

### REFERENCE SIGNS LIST

100 Selection device (learning device)
110 Information acquisition unit
120 Selection unit
130 Output unit
140 Data storage unit
150 Learning unit
200 Network
1000 Drive device
1001 Recording medium
1002 Auxiliary storage device
1003 Memory device
1004 CPU
1005 Interface device
1006 Display device
1007 Input device
1008 Output device

1. A learning device comprising:
a processor; and
a memory storing program instructions that cause the processor to:
execute processing of calculating total priority of a pattern including a specific number of failed facilities while replacing a failed facility in the pattern; and
determine a reference value based on a difference between an approximate solution obtained by the processing and an optimal solution, the reference value being used to select a specific plurality of failed facilities to be preferentially recovered from among a plurality of failed facilities generated in a network that provides a communication service and includes a plurality of facilities.

2. The learning device according to claim 1, wherein
the program instructions cause the processor to determine, as the reference value, a minimum value or an average value of the number of times the processing is executed until the difference becomes 0.

3. The learning device according to claim 1, wherein
the program instructions cause the processor to calculate an acceptance determination value based on total priority at a point in time when the difference becomes 0 and total priority in the processing one before the point in time, and determine the acceptance determination value as the reference value.

4. A selection device comprising:
a processor; and
a memory storing program instructions that cause the processor to:
acquire information regarding a plurality of failed facilities in a network that provides a communication service and includes a plurality of facilities; and
execute processing of calculating total priority of a pattern including a specific number of failed facilities while replacing a failed facility in the pattern, terminate the processing based on a reference value obtained by preliminary learning, and select a specific plurality of failed facilities to be preferentially recovered from among the plurality of failed facilities generated in the network, based on the pattern at a point in time when the processing is terminated.

5. A learning method executed by a learning device that determines a reference value used to select a specific plurality of failed facilities to be preferentially recovered from among a plurality of failed facilities generated in a network that provides a communication service and includes a plurality of facilities, the learning method comprising:
executing processing of calculating total priority of a pattern including a specific number of failed facilities while replacing a failed facility in the pattern; and
determining the reference value based on a difference between an approximate solution obtained by the processing executed by the calculation step and an optimal solution.

6. (canceled)

7. A non-transitory computer-readable recording medium having stored therein a program for causing a computer to perform the learning method according to claim 5.

8. (canceled)
